(19) United States
(12) Patent Application Publication
(10) Pub. No.: US 2008/0052505 A1
(43) Pub. Date: Feb. 28, 2008

(54) Device and Method for Configuration of a Data Processing Unit

(76) Inventor: Holger Theobald, Hohen Neuendorf (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/659,573

(22) PCT Filed: May 13, 2005
(86) PCT No.: PCT/EP05/05246

§ 371 Date: Feb. 7, 2007

(30) Foreign Application Priority Data
Aug. 11, 2004 (DE) 10 2004 039 808.9
Feb. 1, 2005 (DE) 20 2005 001 650.0

(51) Int. Cl. G06F 15/177; H04Q 7/24

(52) U.S. Cl. 713/1; 370/338

(57) ABSTRACT

The invention relates to a device for configuring a data processing system (1), the data processing system (1) having a plurality of components such as a processor (6), main board (4), memory, input/output component (20), power supply component (2) or the like, which can be connected to one another for the configuration of the data processing system (1), characterized in that the system has at least one configuration module (22) which is interposed into the connection of at least two components, that the system has a control module (30) which can be connected to the configuration module (22), that following a signal sent from the control module (30) to the configuration module (22) a connection can be made available between the at least two components, and that by making available the connection between at least two components the data processing system (1) can be configured, and a pertinent process for configuring a data processing system (1).

The invention relates to a device and a process for configuring a data processing system.

Data processing systems for diverse applications are known in the prior art. Generally a data processing system has a processor, for example a central data processor which is also called a CPU, volatile storage means or random access memory, nonvolatile storage means such as for example a hard disk, power supply components such as for example a power supply unit, and at least one input component such as for example a keyboard or mouse, and one output component such as for example a monitor. Configuring of known data processing systems takes place when they are assembled. For this purpose, after selection of suitable components, the later are installed in the housing of the data processing system and are then connected to one another by power and data engineering.

In the event of failure of one component or an increased demand for performance from the data processing system, for example a greater demand for storage space or a higher computing speed, components must be replaced or new components must be installed in the housing of the data processing system and must be connected to the other components. This leads to downtimes of the data processing system and is moreover time-consuming and thus also cost-intensive.

The object of the invention therefore is to make available a generic system for configuring a data processing system and an associated process for configuring a data processing system, which overcome the disadvantages of the prior art. In one special embodiment in particular operating reliability and/or data security of the data processing system which can be configured as claimed in the invention will be increased. In one special embodiment moreover the data processing system is to be adaptable to altered performance requirements with little effort. In another special embodiment new capabilities of administration of the data processing system are to be made available. Furthermore the power consumption of the data processing system is to be reduced.

This object is achieved by the device defined in claim 1 and by the process defined in the subordinate claims. Special embodiments of the invention are defined in the dependent claims.

As claimed in the invention the system has at least one configuration module which is connected to one component of the data processing system. By way of the configuration module the components can be connected to a second component of the data processing system directly or also indirectly by way for example of another configuration module. The configuration module is interposed into the connection of at least two components such that it is located in a connecting channel between the components, the data flow and/or power flow between the two components being able to remain completely undisturbed by the configuration module, or the data flow and/or the power flow being influenced in a definable manner by the configuration module. The configuration module can be connected to a control module, the control module preferably controlling several configuration modules. As is the case with the control by the control module, the configuration module makes available a connection between at least two components. The connection can be made available physically, in particular by switching of connecting lines. Alternatively or in addition virtual connections can also be made available, for example by assigning the components which are to be connected to one another to specific time slots on a data channel, by addressing specific components by means of data addresses which are added to the data which are actually to be transmitted, or the like. At least some of the configuration modules can be configured essentially identically, and for example can differ from other configuration modules only by the interface to the connected components.

The connection between the components in this instance can be specifically a data engineering connection. For example a hard disk can be connected to the configuration module which is simultaneously connected to a hard disk controller on the main board of the data processing means. The configuration module in this case can make available a connection between the hard disk and the hard disk controller according to the control data which have been received from the pertinent control module. In this way, by means of the control data the hard disk can be incorporated into the configuration of the data processing system or, for example in the case of a malfunction of the hard disk, this hard disk can be removed from the configuration of the data processing system.

In the latter case the data which are to be retrieved from the hard disk must then be made available by the other components, for example by another hard disk or another data memory. For the case in which the data are to be written onto the hard disk, likewise another data storage means must likewise be incorporated into the configuration of the data processing system and at least temporarily take over the function of the failed hard disk. The pertinent control, especially disconnecting or connecting components, preferably takes place by means of a system administrator or configuration administrator which can also be an individual, but which is preferably implemented by a controller with the pertinent administration or configuration software.

For connecting the control modules to the controller the control modules preferably have a network connection by way of which the control module can be connected to the control network. The control information for connecting the components and thus for configuring the data processing system can be received from the control module over the network.

In one special embodiment of the invention, data from at least one of the components which is connected to the configuration module can be transmitted from the configuration module to the control module and/or data can be transmitted from the control module to at least one of the components which is connected to the configuration module. On the one hand data therefore can be transmitted between components with configuration modules which are connected to the same control module. If the control module is furthermore connected by way of a control network to other control modules and configuration modules and components which are connected thereto, on the other hand the data can also be exchanged between components which are located at a distance from one another. Accordingly, components located spatially separated from one another can also be used for configuring the data processing system.

In particular, the data processing system can be configured using components of different data processing means which are of themselves independently serviceable, for example using several computers which are in service in a company or in a department of a company. As a result genuine sharing of components or resources is possible, which increases the efficiency of the data processing system which has been configured as claimed in the invention and/or increases system stability, and by means of which moreover major energy savings can be achieved. Furthermore it is possible to isolate the faults which occur, for example by a replacement component being made available for a component having a fault, and in this way, especially without any operating downtime occurring, the fault can be quickly isolated.

Furthermore, compatibility tests can be carried out more easily and more quickly, for example by a new component being made available and its compatibility being tested by temporary incorporation into the configuration of the data processing system.

In one special embodiment the configuration module can also make available a power engineering connection of the component which is connected to it, in particular a connection of the component to the power supply component of the data processing system, for example a power supply unit. This has the advantage that for example in the case of a malfunction, for example an elevated temperature or short circuit of the power supply, the faulty or problematic component can be separated from the power supply of the data processing system and can be shut down in terms of power engineering. Here it is especially advantageous if the components which are connected to the configuration module can be DC-isolated from the other components of the data processing system. This eliminates disruption of other components. DC-isolation can be made available for example by way of an optical coupler, a reed contract, an electromagnetic relay or the like.

Thus for example components can be replaced by first turning off the power of the component which is to be replaced, then inserting the new component, and finally turning the power back on again. The new component can be checked for serviceability before data engineering incorporation into the configuration of the data processing system. For this purpose the configuration module can also contain a measurement function and/or test function, with which the new component can be checked especially for correct connection, for complete contact-making, for basic electrical function and the like.

For power supply of the control module and/or of the configuration module, either a power supply component such as for example an-existing power supply unit can be used, or a separate power supply can be made available locally at the site of the data processing system, for example a battery, a solar cell, or the like, or the power necessary for operation of the components can be transmitted by way of the control network. A battery can be charged for example by way of a solar cell and/or the network. To supply power to the data engineering components of the data processing system, either a power supply component such as for example an existing power supply unit can be used, or the system as claimed in the invention can make available a separate power supply locally Ion site of the data processing system, or the power which is necessary for operation of the components can be transmitted over the control network. The control network can be either a known data network, for example using the Ethernet protocol, or alternatively or in addition to one such data network there can be a separate control network. The power supply can also be provided redundantly, for example it can be possible both by way of an existing power supply component or also by way of a control network. In this way system stability is increased, and/or different loads of the power supply components can be equalized (load balancing). Moreover, several power channels can be trunked and thus high supply powers can be made available. It is especially advantageous that the connections of the components for power supply can be controlled such that only the respective component which is currently being used can be supplied with power.

In one special embodiment the power required for operation of the control module and/or of the configuration module can be transmitted over the control network.

In one special embodiment, some of the components of the data processing system which has been configured by the system are located spatially remote from the other components of the data processing system which has been configured by the system. In this way, during the configuring, components or resources which are located spatially remote from one another can be accessed. The components can be located for example within a common space or office, distributed among different offices of a department or a company, or can also be distributed among different locations. It is for example possible to configure a data processing system from components, of which the keyboard, monitor and the main board with the processor are located locally at the user site, and which are connected otherwise over a network, specifically the control network, to a storage which may be spatially very remote. For the case in which at least temporarily higher computing power is necessary, the system as claimed in the invention can also incorporate another processor or several other processors which can likewise be located spatially remote from one another into the configuration of the data processing system.

In one special embodiment at least some of the components of the data processing system which has been configured by the system are located in a pool of components which are retained for configuration. For example, data memories such as hard disks, CD/DVD drives and the like can be retained in a corresponding data memory pool, and by way of a network, especially the control network, they can be permanently or temporarily incorporated into the configuration of the data processing system. It is advantageous for the transmission speed over the network to be relatively high in order to enable efficient incorporation of even remotely located components into the configuration of the data processing system. Preferably a definable data transmission rate can be ensured by trunking of channels.

In a special embodiment the signals and/or the data can be transmitted wirelessly between the configuration module and the control module. Alternatively or in addition, the connection between the control module and the network can also be wireless, especially the control network, and/or the control network is a wireless network. Wireless transmission can take place for example optically or by radio, including a radio link using the protocols WLAN (Wireless Local Area Network), Bluetooth, GSM, or UMTS. In this way a data processing system can also be configured with the incorporation of components, of which at least some of the components move relative to one another. For example, in the case of a malfunction of an embarked computer on a vehicle or aircraft, a stationary component or a component of another vehicle or aircraft can be at least temporarily incorporated into the configuration by way of wireless transmission and as a result operating reliability can be greatly increased. In addition to system stability, the load on components which occurs can also be equalized.

The sharing of components or resources which is enabled by the system as claimed in the invention can take place on a time basis, for example by assigning time slots to certain components, or by assigning synchronous or asynchronous data packets in a data channel to components using assigned component addresses. Alternatively or in addition, sharing can also take place on a component basis, for example by temporary or permanent incorporation of specific ports of control modules or entire components into a configured data processing system. Furthermore, alternatively or in addition, sharing can also take place by partitioning of components, for example by partition of a hard disk and assignment of partitions of the hard disk, for example a definable number of sectors, to different configurations of the data processing system. In this way for example several data processing systems which have been configured as claimed in the invention can jointly access a physically uniform hard disk without the data accesses of the different data processing systems colliding.

The invention also relates to a process as claimed in the invention for configuring a data processing system as described in the foregoing. In one special embodiment, in a data processing system which can be configured as claimed in the invention, data streams can be duplicated and/or uniform settings of software configurations can be implemented on several data processing systems which can be configured as claimed in the invention, for example uniform settings in the BIOS (Basic Input Output System) can be implemented. For this purpose, the components of several independently serviceable data processing systems which can be configured as claimed in the invention and which are optionally also located remote from one another can be disconnected from their configuration of the respective data processing system and temporarily connected by way of a network, especially the control network, to a reference data source. In this way it is possible, for example during typical unattended times, for example overnight, to provide a plurality of data processing systems with a software update. After completed loading of software onto components, they are incorporated as originally configured into their respective data processing system.

Such a software update can also take place while the user is working on the data processing system without the user directly having knowledge of the software update. For this purpose for example the components required by the user can be temporarily made available in some other way, while in the background the software update for the components used by the user in the original configuration of the data processing system is running.

Moreover the configuration modules can sniff, buffer, duplicate, log the data traffic between the components routed over them, and in particular can send it via the pertinent control module and/or the control network and at least temporarily store it at a remote site. This is possible for example independently of the direction of the data traffic, i.e., both for the data which have been sent from the component and also for the data which have received from the component. In this way the data traffic can also be reconstructed at a later time in a replay mode, for example for troubleshooting or fault identification, for emulation purposes, for data security or the like.

Analogously, back-up of components of a data processing system can take place for example by temporarily switching the corresponding components from the pertinent configuration module to a connection to back-up storage, optionally also over the network, especially the control network.

In one special embodiment it is also possible to remove a component from the configuration of the data processing system and in its place alternatively feed a data stream into the remaining data processing system, with which stream the removed component is emulated. In this way virtual control modules can be created, for example the required keyboard inputs when booting up the data processing system can be made available by emulating the component keyboard, or other components such as plug-in cards, hard disk controllers up to partial systems or independently executable data processing means can be emulated.

In one special embodiment of the invention, data transmission between the configuration module, the control module and/or the network takes place using encryption technology and/or filtering, for example to ensure protection against computer viruses. Moreover different priorities can be assigned so that important data are transmitted in preference. Furthermore, specific bandwidths for data transmission can also be guaranteed, for example for specific components, for specific data addressees and/or for specific data contents such as for example interrupts or the like.

The configuration module can be located for example between a hard disk and the hard disk controller which is generally located on the main board. Alternatively or in addition, a configuration module as claimed in the invention can also be located between the main board and the hard disk controller. Furthermore it is possible to design the configuration module in a unit with the control module. The configuration module, the control module, and/or the network connection can be located on a separate board which can be designed as a built-in card or plug-in card. Alternatively, the configuration module, the control module and/or the network connection can also be integrated in the components, for example can be integrated on the main board or can be integrated in the hard disk.

Alternatively or in addition, the configuration module as claimed in the invention can also be integrated on the main board, and/or can be integrated in a component of the data processing means, and/or can be located in the local vicinity of the data processing means, in particular at the interfaces for peripherals on the outside of the data processing means, for example in the form of a port replicator and a docking station, as are used for example in notebook computers.

The configuration modules and/or control modules can also be provided at least in part redundantly, for example to increase system stability, to enable distribution of the data traffic (load balancing), to guarantee a definable bandwidth for data transmission, to enable channel trunking, to enable higher power transmission for operation of components or the like. Moreover specific configuration modules and/or specific control modules can be reserved or used preferably for definable tasks, for example for mirroring or logging the data traffic between two components. Moreover specific configuration modules can be assigned to specific controllers, in particular administration controllers, for special tasks such as for example for mirroring or logging the data traffic between two components.

The present invention furthermore relates to a device for a data processing means, especially a built-in card for controlling the data processing means by way of a network. Alternatively or in addition to implementation as a built-in card, the device can also be integrated on the main board, and/or can be integrated in a component of the data processing means, and/or can be located in the local vicinity of the data processing means, especially at the interfaces for peripherals on the outside of the data processing means, for example in the form of a port replicator and/or docking station, as are used for example in notebook computers.

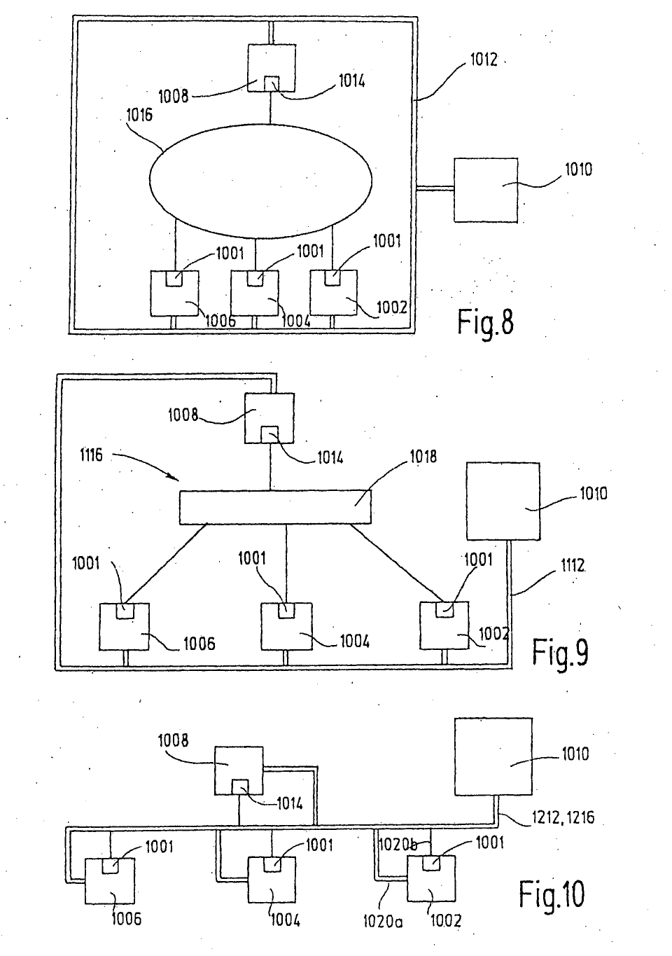

This further aspect of the invention can be implemented independently, especially as described below, as is shown in FIGS. 8 to 12, and/or as defined in the pertinent subordinate claims 14 to 25, or the further aspect can be implemented in conjunction with the initially described aspect of the invention, especially the initially described configuration module being implemented by the device as claimed in the invention which is described below.

It is conventional for data processing means, such as for example personal computers, to be networked with one another in terms of data engineering over a data network. The data are exchanged over the data network according to a standardized protocol, for example according to the Ethernet protocol. In many applications the data networks are hierarchically structured with one or more network nodes to which so-called client computers are connected which are conventionally workstation computers, or so-called server computers which generally have a higher capacity than client computers.

In many applications the client computers are located spatially remote from one another, for example in different rooms of a building, in different buildings at one location and/or at different locations. Especially in a company environment it can happen that the data processing means are located several hundred or even several thousand kilometers apart from one another.

In the context of maintenance and system servicing it can be necessary that one, several or all data processing means which are networked to one another in terms of data engineering be accessed. Generally this takes place by a so-called system administrator which is authorized to access the data processing means over the data network from the server computer or one of the client computers and to carry out the necessary actions. This can be for example an update of the software which has been installed on the server computer or the individual client computers, balancing of the data on the server computer or the individual client computers, or the like. For this purpose it can be advantageous for specific interfaces of the data processing means to be inactive or not be become activated. If necessary an individual must be assigned to placing the data processing means in the required operating state. This is associated with considerable time expenditure and costs.

Therefore the object of the invention is to make available a device which overcomes the disadvantages of the prior art.

This object is achieved by the device which is defined in claim 14. Special embodiments of the invention are defined in the dependent claims.

In a device, especially a built-in card, for a data processing means, for example for a computer, a printer or the like, the data processing means being networked by data engineering to at least one other data processing means, and the data processing means having a main board with interfaces for other components of the data processing means and/or for interaction of the data processing means with a user, including an interface for sending and/or receiving data to or from a peripheral of the data processing means, and the device being connected over a network to a controller, the object is achieved in that the device has a power supply which is independent of the data processing means by way of the network, and that the device is connected to at least one of the interfaces for sending/or receiving data to or from a peripheral of the data processing means.

Preferably those interfaces over which application data or program data can be sent or received are connected to the device. In this way the data flow to or from the data processing means can be monitored by means of the device. It is for example possible to control that at certain times no data or only certain data may be sent, the determination of the data being possible with different parameters, for example file names, creation date, file size and the like; thus the unauthorized copying of data can be prevented. Analogously, the reception of data can be monitored so that unauthorized transfer of data over the interface which is monitored by the device is not possible.

In this instance it may consist of a so-called Universal Serial Bus (USB) interface which is connected to the device and can be monitored by the device. This interface can be activated, deactivated, locked and/or unlocked by the device, controlled by way of the network and the controller, i.e., for example by a network administrator. For example, access to the data processing means over the USB interface can be allowed only at times which have been dictated by the administrator. Thus for training purposes security-relevant data can be transferred onto a data processing means, and during training the copying of these data onto a data medium which is connected to the monitored interface can be prevented.

Alternatively or in addition to a control intervention, the device can also simply monitor the interface and qualitatively and/or quantitatively log the data traffic over this interface and/or send it over the network to the controller and/or to an administrator so that if necessary unauthorized data transfer over the monitored interface can be detected and optionally can also be interrupted.

The data network over which the data processing means are networked by data engineering to one another can be designed DC-isolated relative to the network with which the device as claimed in the invention is connected to the controller. Such an embodiment of the invention has the advantage that the data transmission speed for data traffic on the data network is not reduced by the data traffic between the device and the controller. In addition, the power supply of the device as claimed in the invention can be made available with simple means.

In one alternative embodiment of the invention the data network and the network for the connection between the device as claimed in the invention and the controller are integrated in a common network. This common network for example can be built up on an already standardized network protocol and can be expanded simply by the functionalities of the device as claimed in the invention. In this case the power supply of the device as claimed in the invention takes place independently of the power supply of the data processing means.

The interfaces of the main board are not only the known standardized interfaces for data transmission or triggering of other components of the data processing means, such as for example the so-called IDE interface for connection of hard disks, the so-called PCI interface for connection of plug-in cards, and the parallel and/or serial interface, but basically all interfaces of the main board with connectable components, for example with actuating switches, input devices such as the keyboard or mouse, or output devices such as indicator lamps, speakers or monitors. Thus, for example the currently popular personal computer on its main board has interfaces for light emitting diodes for display of the on state and activity of a disk storage, in the same way as a button or switch for turning on and off and a button for resetting (RESET) of the data processing means.

The main board is generally a comparatively large circuit board on which the important components of a computer system are located, especially the processor which is also called the central processing unit (CPU). Other components such as for example memory modules, plug-in cards for sound, graphics, video, networks, or modem, can generally be detachably fixed on the main board by way of the corresponding plug connection means.

In one special embodiment of the invention it is moreover possible to turn on, turn off and/or reset the data processing means controlled by the controller. In this way for example for transferring updated software onto the data processing means even from an administrator working far away, a data processing means which is off can first of all be turned on, then the software can be updated and finally the data processing means can be turned off again. Moreover the data processing means if necessary can be reset into the base state by way of the device, for example restarted, when it happens that the data processing means cannot be regularly addressed by way of data engineering networking. This can all take place without an operator starting to work locally on the data processing means.

For this purpose it is especially advantageous for the power supply of the device to be independent of the power supply of the data processing means. Modern data processing systems are in the so-called stand-by mode even in the off state from which they can be put into operation easily with the device as claimed in the invention. This applies both to a first possible stand-by mode, in which the data processing means is certainly turned off, but the power supply unit is supplying the main board with power, and also in a second possible stand-by mode in which the main board supports the corresponding power savings modes such as for example the APM (advanced power management) or ACPI (advanced configuration power interface) in which parts of the data processing means are turned off and can be re-activated by actuating a key.

The connection of the device to the interfaces of the main board of the data processing means preferably takes place by conductive connection, for example by looping through the connecting lines between the main board and the other components of the data processing means over a board of the device as claimed in the invention. In the device DC-isolating between the control and the looped-through connecting lines can take place, for example by an optical coupler which is located on the board of the device or by a switch which can be actuated electromechanically, such as for example a relay or a reed relay. The device as claimed in the invention can have detachable connecting elements, in particular plug-in or screwed connecting elements which are compatible with the corresponding connecting elements of the data processing means so that the device can be installed by simply unplugging and plugging the existing connecting lines of the data processing means.

Both the data network and also the network between the device and the controller can be implemented in pure form or mixed form of different network types. Basically peer-to-peer networks and client-server networks are distinguished. Peer-to-peer networks are a simple possibility for connecting several computers to one another, generally the individual data processing means having equal access in a peer-to-peer network. The user of the data processing means himself determines which data and devices he releases for the access of others. Here it also applies that the resources of a data processing means can only be used when it is in the on state.

Within the scope of this invention the networks will be designed preferably as a client-server network, which in contrast to the peer-to-peer network is hierarchically structured. In a client-server network a so-called server computer takes over central tasks, for example the administration of network resources such as hard disks, printer, modem, scanner and the like, and providing services such as for example computing power. Generally a server computer operates several client-computers at the same time. The networks can be configured in different topologies, for example star, ring, bus, tree and mesh topology, mixed forms also being possible.

In one special embodiment of the invention the device is connected to a power supply unit of the data processing means, especially to the power supply line of the power supply unit for another component of the data processing means. In this way it can be easily determined for a device whether the data processing means is on or off. Preferably one of the numerous power supply lines of the power supply unit which are not needed for the data processing means is connected for this purpose to a board of the device. The operating state of the data processing means which is determined in this way can be transmitted from the device to the controller so that for example an administrator can decide whether specific measures, for example transferring of updated software, is possible in the respective operating state of the data processing means.

In one special embodiment of the invention the device is connected by way of an interface to a display element or sensor element which is present in the data processing means. For example, the operating state of one or more of the light emitting diodes which are located on the housing of the data processing means and which display the operating state or the access of a data memory can be determined and can be transmitted to the controller over the network. Furthermore, many data processing means have sensor elements for the temperature of the processor or the main board, or for the rotational speed of a fan; this information can also be transmitted by way of the device and the network to the controller and for example to an administrator.

In one special embodiment the device is connected to the so-called System Management Interrupt (SMI) interface of the main board. This for example double-pole interface makes it possible to shift the data processing means into the energy saving mode, for example by storing the current content of the random access memory on a partition of the hard disk which has been established beforehand, from which the contents are reloaded into the random access memory when the data processing means is restarted.

In one special embodiment of the invention the device is connected to other standardized interfaces of the main board, for example for data transmission to or from peripherals of the data processing means. Examples of these standardized and currently conventional interfaces or data bus protocols are for example parallel and series interfaces, Accelerated Graphics Port (AGP) interfaces, Firewire interfaces as per IEEE Standard 1384, interfaces for wireless transmission by optical waves or radio waves such as Bluetooth or infrared and the like; this list is not final and future interfaces and standards also can be controlled as claimed in the invention. By the device as claimed in the invention these interfaces can be temporarily or permanently deactivated or activated from a remotely located administrator without the need for intervention locally on the data processing means.

The device can also control several or all of the functions which can be set with a so-called jumper on the main board, instead of simple wire bridges often board switches being used at present. In this way it is unnecessary to open the housing of the data processing means to implement settings on the clock frequency or to write the read-only memory, for example to flash the BIOS (Basic Input Output System) of the data processing means. Preferably for this purpose the pertinent connections are routed from the main board to the device, similarly to the interfaces which are to be controlled.

In one special embodiment of the invention the device has at least one sensor element for recording the status of the data processing means or of ambient conditions of the data processing means, and this status information can be transmitted to the controller over the network. With sensors for temperature, humidity and/or air pressure for example the ambient atmospheric conditions can be recorded and transmitted to the controller. Alternatively or in addition, photosensors, for example simple photodiodes, and still cameras and full video cameras can be provided, by means of Which optical inspection of the data processing means is also possible from a remote location, even when the data processing means has been turned of by the user; if necessary a lighting means for illuminating the data processing means can also be integrated into the device.

Another possibility can be a housing switch by means of which opening of the housing of the data processing means can be detected. Alternatively or in addition, opening or closing of the housing can also be detected by an air pressure sensor. With a sensor for air circulation for example alone or in combination with a temperature sensor, it can be detected whether adequate cooling of the data processing means is ensured. With a microphone or vibration sensor for example especially vibrations which are unallowable in the operating state can be detected and signaled. The display elements which are already present in the data processing means can be used for signaling of specific, for example critical operating states, for example a so-called system warning speaker or light emitting display diodes which can be triggered by the controller over the network and the device as claimed in the invention.

Alternatively or in addition there can also be other sensors, for example a photosensor or light sensor, a magnetic sensor or an ultrasonic sensor, for example for detecting the opening of the housing of the data processing means. Alternatively or in addition there can also be atomic, biological and/or chemical sensors.

Atomic sensors can for example detect radioactive radiation and the latter can be signaled over the network, even if other parts of the data processing means are no longer serviceable due to the radioactive radiation. The pertinent sensors and the device as claimed in the invention should preferably be designed to be especially radiation-resistant, for example by using special circuits which are still serviceable in the case of radioactive radiation, for example by using silicon-on-insulator technology for integrated circuits. Power supply of the device over the network ensures that radioactive radiation is still reported even if the local power supply of the data processing means has failed, and for example a warning signal or call for help can be transmitted from the device.

Biological sensors can detect a hazard potential especially for living creatures, and a warning can be signaled locally at the site of the data processing means and/or a warning signal or call for help can be transmitted over the network.

Chemical sensors can detect various hazard situations. For example, in the case of fire being extinguished in the space of the data processing means using carbon dioxide or halogens, it can be signaled that the space may not be entered by individuals or at any rate not without protective breathing apparatus. Or it can be detected whether there is smoking in a prohibited zone, and even unignited smoking products can be detected by correspondingly sensitive sensors. Moreover chemical sensors can also detect sources of fire, even before their onset based on the evolution of gases from plastics which occurs beforehand.

One special advantage is that due to the plurality of measurement points, sensor technology can be installed over a large area, as a result of the spatial or geographic position of the data processing means which is generally known also spatial or geographical assignment of measurement results being possible, and moreover also the spatial and also geographic propagation of the failures detected by the sensors can be determined.

In one special embodiment of the invention, the data processing means can be shifted into the operating state in which interaction is possible only by way of the device, the network and the controller. In particular, an interaction, for example turning on or turning off or data input via a keyboard or mouse by the user can be prevented locally at the site of the data processing means. In this way for example when updating of the software is underway, it is possible to prevent the data processing means from being turned off by a user locally on site or its being transferred into an operating state which is unallowable for updating the software. As a result, as claimed in the invention only specific local interactions can be prevented; for example data inputs via the keyboard or mouse can still be allowed, but turning off the data processing means can be prevented.

In one special embodiment of the invention the device is configured as a built-in card, the built-in card itself or an adapter fixed on it being configured such that it can be installed in the rack of the data processing means which is standardized with respect to the geometrical dimensions of its acceptance opening. Alternatively or in addition, the device can also be integrated onto the main board, and/or can be integrated in a component of the data processing means, and/or can be located in the local vicinity of the data processing means, especially at the interfaces for peripherals on the outside of the data processing means, for example in the form of a port replicator or a docking station, as are used for example in notebook computers.

Other advantages, features and details of the invention are specified in the dependent claims and the following description in which several embodiments are described in detail with reference to the drawings. Each of the features mentioned in the claims and in the specification may be essential to the invention singly or in any combination of features.

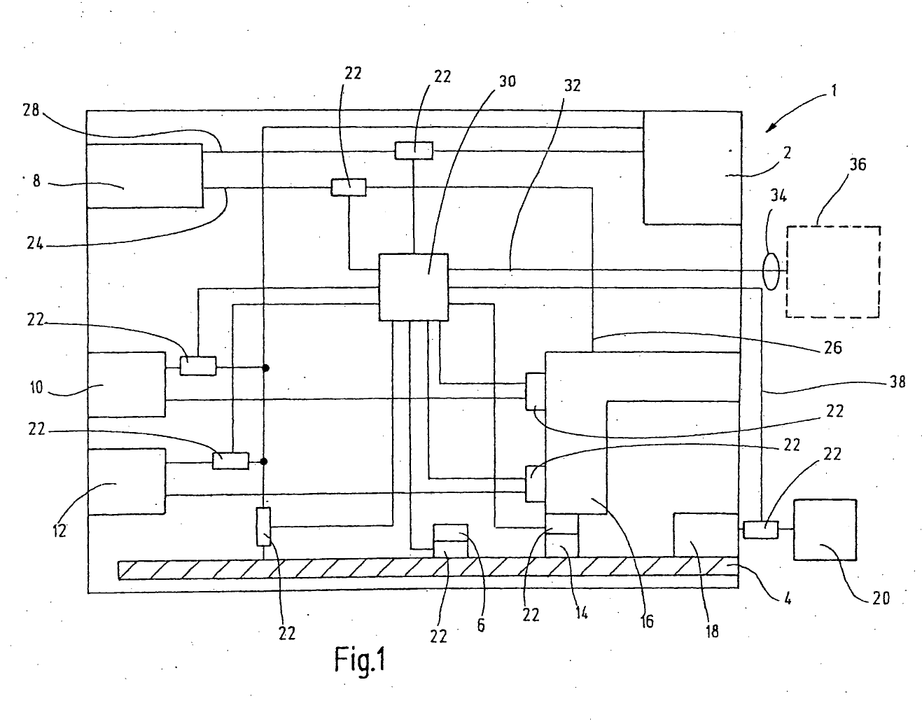

FIG. 1 shows a block diagram of the system as claimed in the invention,

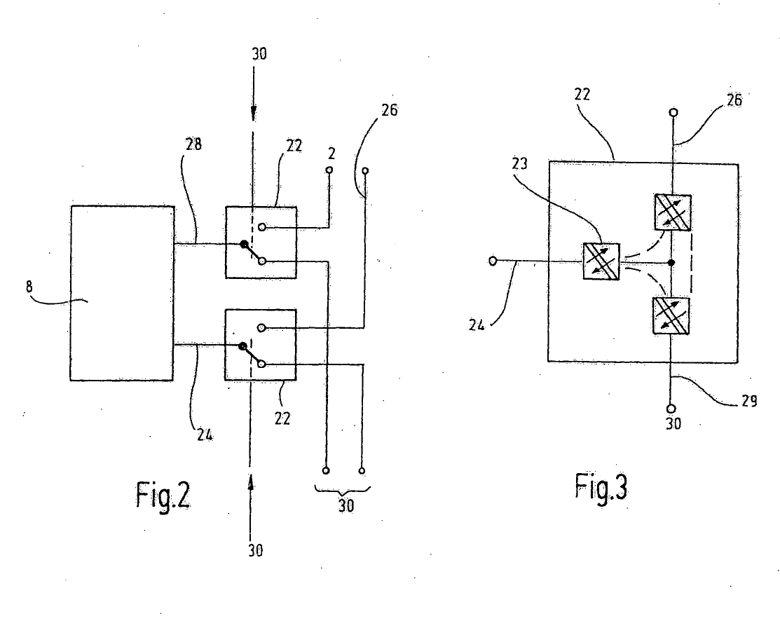

FIG. 2 shows a block diagram of an enlargement of the connection of the hard disk to the configuration module,

FIG. 3 shows a schematic of the triple gate which is formed by the configuration modules,

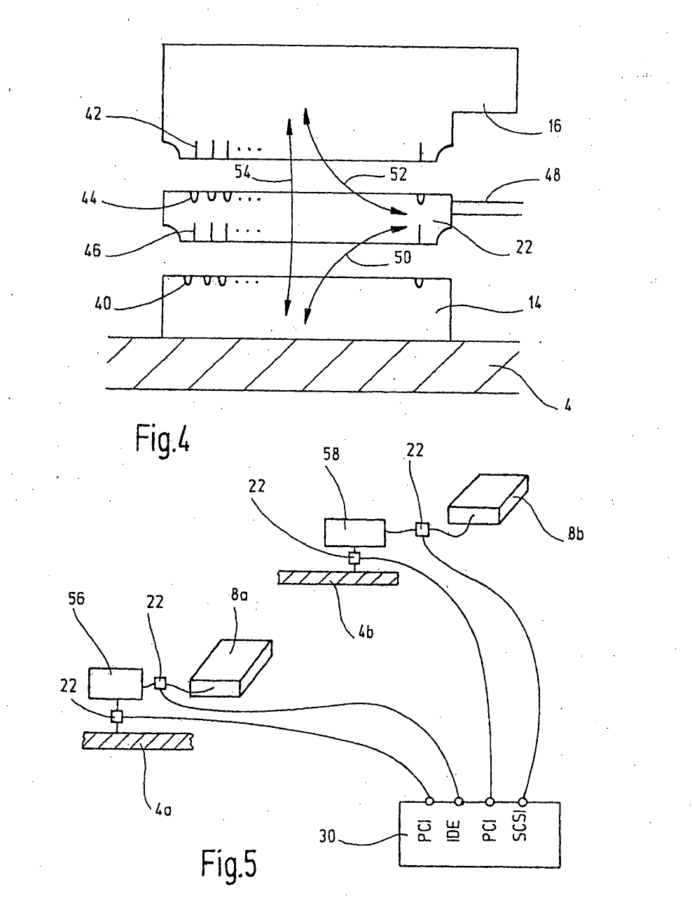

FIG. 4 shows an enlargement of the arrangement of the base of FIG. 1,

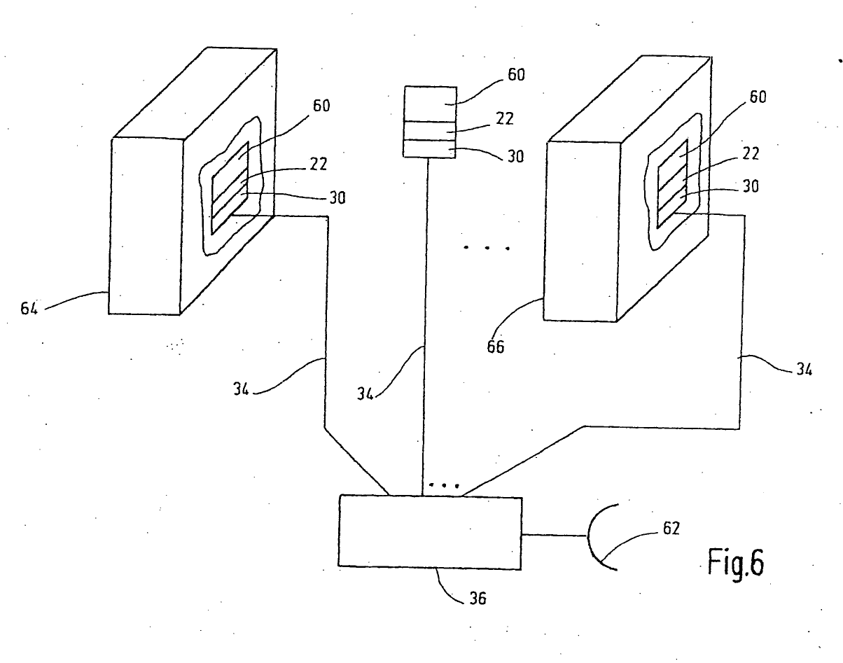

FIG. 5 shows one alternative embodiment,

FIG. 6 shows another embodiment of the invention,

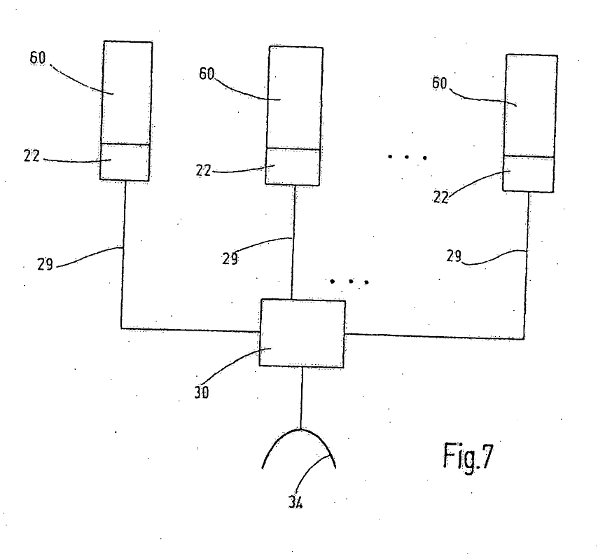

FIG. 7 shows an arrangement of components which each are connected to a configuration module,

FIG. 8 shows one arrangement of a device as claimed in the invention,

FIG. 9 shows one alternative arrangement,

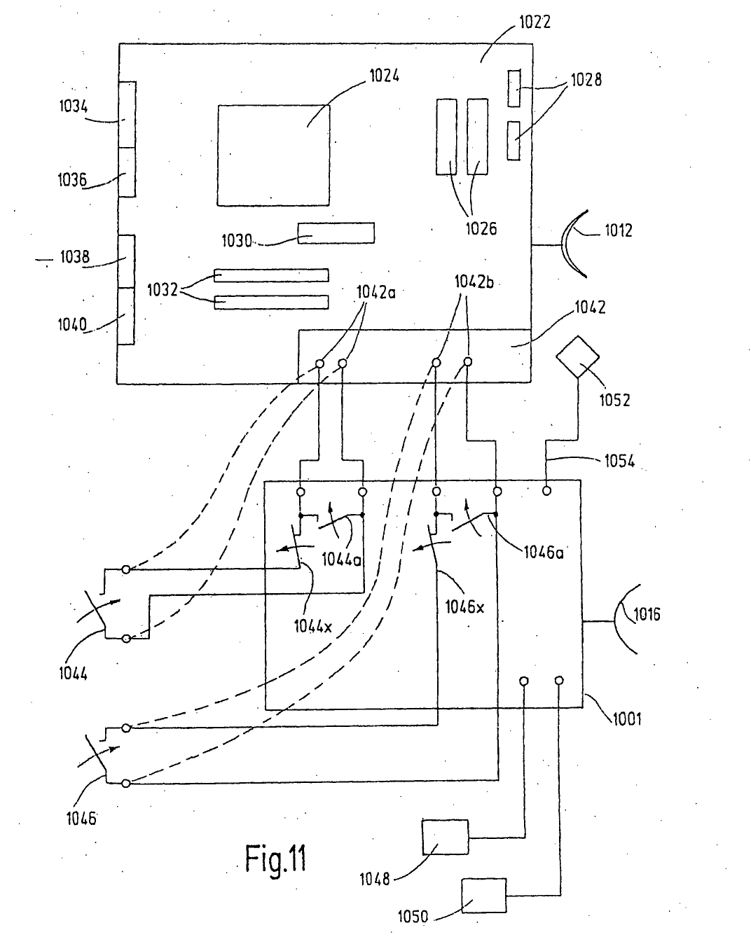

FIG. 10 shows another possible arrangement of data processing means which have been equipped as claimed in the invention,

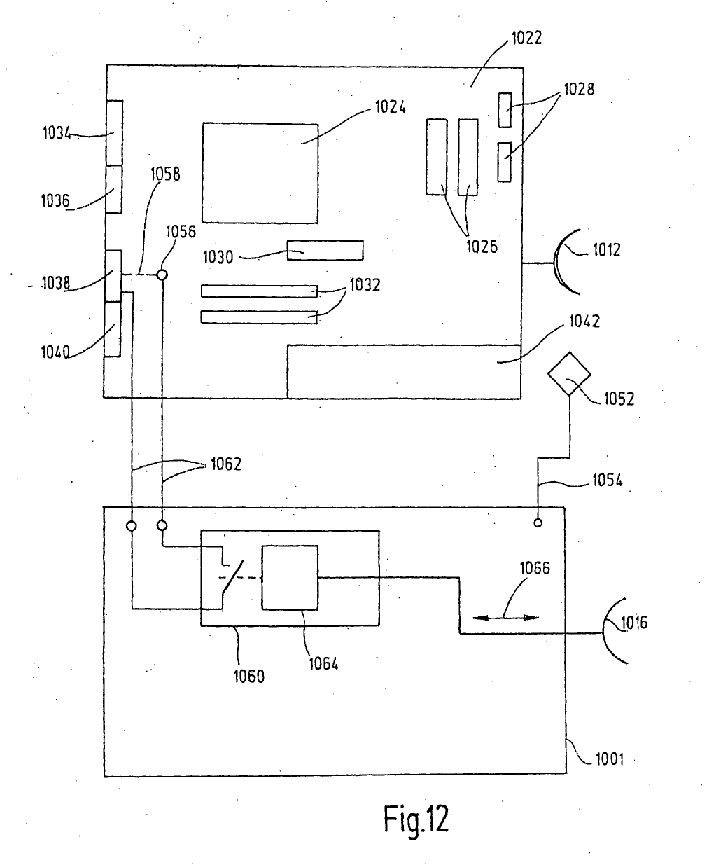

FIG. 11 shows the wiring of a device as claimed in the invention with a main board of the pertinent data processing means, and

FIG. 12 shows the wiring of the device as claimed in the invention with a USB interface or the pertinent USB port on the main board.

FIG. 1 shows a block diagram of a system as claimed in the invention for configuring a data processing system 1. In the embodiment shown the data processing system 1 is structured as a commercial personal computer and in particular has a plurality of components, for example a power supply unit 2, a main board 4, a central processing unit CPU 6 located on the main board 4, a hard disk 8, a CD drive 10 and a DVD drive 12. Moreover plug-in cards can be inserted into the main board 4 in sockets 14 located there, of which cards in FIG. 1 for example only one plug-in card 16 is shown, on which a so-called IDE or SCSI controller for connection of the hard disk 8 is located and moreover also controllers for the CD drive 10 and the DVD drive 12. In addition, on the main board 4 there are one or more controllers 18 which are designed for connection of input/output components, of which in FIG. 1 for reasons of clarity only one keyboard 20 is shown. To the extent described so far, the data processing system 1 is a conventional computer or personal computer. Ordinarily the components are mounted hard-wired within the housing of the computer and are connected to one another.

As claimed in the invention, a plurality of configuration modules 22 are installed in the data processing system 1, each interposed into the connection of two components. Thus for example a configuration module 22 is connected between the data terminal 24 of the hard disk 8 and the data terminal 26 of the hard disk controller which is integrated on the plug-in card 16. Analogously, another configuration module 22 is interposed into the connection between the power terminal 28 of the hard disk 8 and the power supply unit 2. The two configuration modules 22 are connected to the control module 30, which can send control signals to the configuration module 22 and in this way for example can make or break the connection of the power supply unit to the power terminal 28 of the hard disk 8. Analogously, the control module 30 can interrupt or establish the data connection between the hard disk 8 and the controller which has been integrated on the plug-in card 16. The control module 30 has a network terminal 32 over which the control module 30 can be connected to a control network 34 and by way of the control network 34 is connected to a configuration controller 36 which is located outside and optionally also very remote. From this configuration controller 36 the control module 30 receives the signals for making available or breaking the connection of the components which are connected to the respective configuration module 22.

The network terminal 32 which is shown only symbolically by a single line can also be implemented by several lines. This enables especially also the transport of power which is increased according to the number of lines used, over the network to the control module 30. This power can be used for supply of components of the data processing system 1 independently of the power supply unit 2 and can be supplied to the components of the control module 30 by way of the respectively pertinent configuration modules 22.

Moreover the configuration module 22 can also transmit data from the hard disk 8 over the control module 30 and the control network 34 to the configuration controller 36 or to other components. Analogously, the data which have been received by way of the control network 34 from the control module 30 can also be fed over the configuration module 22 into the hard disk 8 and/or into the hard disk controller which is integrated into the plug-in card 16.

As described above using the hard disk 8, the other components of the data processing system 1, especially the CPU 6, the plug-in card 16, the keyboard 20, the CD drive 10 and the DVD drive 12 can be connected to one another by way of one configuration module 22 each. The main board 4 is connected for example by way of the configuration module 22 to the power supply unit 2, so that by controlling the pertinent configuration module 22 the main board 4 can be switched off-circuit. Conversely the main board 4 including the CPU 6 located on it can be supplied with electric power, whereas the other components of the data processing system 1 shown in FIG. 1 remain de-energized. This is especially recommended for example when the computing power of the CPU 6 is to be temporarily or permanently incorporated into the configuration of the data processing system which is shown only partially in FIG. 1 over the configuration module 22, the control module 30, and the control network 34. Analogously, other components or groups of components can also be incorporated into the configuration of the data processing system which is not completely shown in FIG. 1. All data communication takes place in this case over the control module 30 and the control network 34.

In contrast to FIG. 1, it is also possible to make available the components of a personal computer over more than one control module 30 for the configuration of a data processing system 1. The possibility also exists of making at least some of the data connections shown in FIG. 1 wireless, for example between the control module 30 and the configuration modules 22, between the control module 30 and the control network 34, or with respect to the control mechanism 34, especially by WLAN, Bluetooth, GSM or UMTS.

The controller 18 which is shown in FIG. 1 merely as a simple version can be present in numbers, in particular numerous interfaces of the data processing system 1 can be provided, such as for example USB, PS/2, Firewire, parallel interface, serial interface, ISDN, audio interface, network card, local area network LAN, wireless local area network WLAN, VGA or DVI. As shown in FIG. 1, for some of these interfaces the configuration module 22 certainly can also be plugged onto the respective interface from outside the housing of the data processing system 1. Here it is also possible for data to be branched off from the keyboard 20 to the control module 30 for example over the connection 38 between the configuration module 22 and the control module 30, and further over the control network 34. Analogously it is also possible over the control network 34, the control module 30 and the connecting line 38 to the configuration module 22 to feed keyboard signals, for example from the configuration controller 36, into the interface of the controller 18 and in this way to emulate a keyboard.

FIG. 2 shows a block diagram of an enlargement of the connection of the hard disk 8 to the configuration module 22 to which the power terminal 28 of the hard disk 8 is connected, and the configuration module 22 to which the data terminal 24 of the hard disk 8 is connected. Within the configuration module 22 there is a respective changeover switch with which the terminals of the hard disk 8 can be switched either to the other components of the data processing system 1, for example the power terminal line 28 to the power supply unit 2 and the data terminal line 24 to the data terminal line 26 of the controller which is integrated in the plug-in card 16. Control of the changeover switch takes place according to control signals of the control module 30. In the switch position shown in FIG. 2 the hard disk 8 is connected to the control module 30 both with respect to its power terminal 28 and also with respect to its data terminal 24 and accordingly receives its power from the control module 30 and sends the data to the control module 30 and/or receives the data from the control module 30. The two configuration modules 22 can also be switched independently of one another. Moreover a third intermediate position can also be possible, in which the hard disk 8 is completely DC-isolated in terms of power engineering and/or data engineering from the other components of the data processing system 1, including the control module 30. Instead of the changeover switch shown in FIG. 2, there can also be other electrical or electronic switching devices, for example optical couplers, switching transistors or the like. Instead of the physical transfer which is shown in FIG. 2, a virtual transfer or a virtual connection can also be made available by providing the corresponding computer intelligence in the configuration modules 22, by means of which for example in specific time slots the data terminal line 24 of the hard disk 8 is connected to the data terminal line 26.

FIG. 3 schematically shows a schematic of the triple port which has been formed by the configuration modules 22, in FIG. 3 only the connection relating to the data terminal line 24 of the hard disk 8 being shown. For many applications it is advantageous if the connection can be switched such that the terminal lines can be DC-isolated from one another on the triple port. This can take place for example by the optical coupler 23 which is shown schematically in FIG. 3. The control signals for the configuration module 22 can be transmitted over the data connecting line 29 or over separate control lines which are not shown in FIG. 3 for the sake of clarity. Corresponding to the control signals, a connection of the data terminal line 24 can be made selectively to the data terminal line 26 to the controller or to the connecting line 29 to the control module 30. Furthermore, it is possible for the data connection line 24 to be decoupled, preferably also DC-isolated, and for a data connection to take place simply between the data terminal line 26 of the plug-in card 16 and the connecting line 29 to the control module 30. Furthermore it is optionally possible to turn off all triple ports and especially to DC-isolate them from one another.

FIG. 4 shows an enlargement of the arrangement of the socket 14 of FIG. 1. The socket 14 is located permanently on the main board 4 and has a plurality of contact elements 40 which interact with the corresponding contact elements 42 which are located on the plug-in card 16. The socket 14 is designed for plugging in the plug-in card 16. Between the socket 14 and the plug-in card 16 a configuration module 22 is plugged in which on its side facing the plug-in card 16 has contact elements 44 which correspond to the contact elements 40 of the socket 14. On its side facing the socket 14 the configuration module has contact elements 46 which correspond to the contact elements 42 of the plug-in card 16. Thus the configuration module 22 can be connected between the socket 14 and the plug-in card 16 without the need for a change on the socket 14 or the plug-in card 16. The configuration module 22 is connected over the connecting line 48 to the control module 30. The configuration 22 is designed such that both only one data exchange can take place between the control module 30 and the socket 14 and thus the main board 4, as is indicated by the double arrow 50, or only one data exchange between the control module 30 and the plug-in card 16, as is indicated by the double arrow 52, or only one data exchange between the plug-in card 16 and the socket 40, as is shown by the arrow 54. Depending on the application, combinations of these connections can be allowed, in particular there can be only one data exchange in one direction. Thus, for example it is possible to take data from the plug-in card 16 by way of the configuration module 22 and to transmit them over the control module 30 and optionally also the control network 34 and/or to feed the data which have been received over the control network 34 and the control module 30 into the socket 14 and thus into the main board 4. For example, in the case shown in FIG. 1 in which the plug-in card 16 contains the controller for the hard disk 8 (FIG. 1), for example a virus scan of the hard disk 8 can take place over the connecting line 48, or also reading of data from the hard disk 8, or writing of data onto the hard disk 8.

FIG. 5 shows one alternative embodiment in which components of two different data processing means which can be operated each independently, for example of two personal computers, are incorporated in a data processing system which is configured as claimed in the invention. For this purpose, for example a first hard disk 8a, which is a so-called IDE hard disk, with interposition of a configuration module 22, is connected to an IDE controller 56 which in turn is connected to a first main board 4a of the first data processing means with the interposition of a configuration module 22. Analogously, a second hard disk 8b which is a SCSI hard disk is connected via a configuration module 22 to a SCSI controller 56 which in turn is connected by way of a configuration module 22 to a second main board 4b of the second data processing means. By interposing one configuration module 22 each both into the connection between the hard disk 8a, 8b and the controller 56, 58, and controller 56, 58 to the first and second main board 4a, 4b, on the control module 30 both a data stream can be extracted or supplied as it is being processed on the main boards 4a, 4b, for example according to the PCI bus format, or the data can be made available in the format which has been converted by the respective controllers 56, 58, in this case IDE or SCSI. As a result the controller function can be shared in the data processing system which is to be configured. In particular it is advantageous that, for example when transferring data onto the hard disks 8a, 8b, the respectively pertinent controller 56, 58 need not be in operation within the data processing means.

FIG. 6 shows another embodiment of the invention. In a first data processing means 64, for example a first personal computer, there also is a component 60 which is connected to a configuration module 22 and to a control module 30 which is located in the first data processing means 64. The control module 30 is connected over a data line or a control network 34 to the configuration controller 36. A second data processing means 66 is also built analogously in this respect. Moreover there is still another component 60 which is likewise connected to a configuration module 22 and a control module 30 as well as a data line, or a control network 34 is connected to the configuration controller 36, but not in a unit with another data processing means. The other component 60 is independent and is intended for example as a replacement component or additional component for configuring a data processing system as claimed in the invention.

If necessary, the component 60 of the second data processing means 66 can be incorporated by way of the configuration controller 36 into a data processing system which is to be configured as a substitution or in addition to the components of the first data processing means. FIG. 6 accordingly illustrates the basic idea of this invention, that is, interlinking components or resources which can be arranged spatially distributed, optionally very remote from one another, and in this way configuring a data processing system which is arranged in a distributed manner. The configuration need not be permanent, in particular it can be temporary according to the performance requirements imposed on the data processing system which is to be configured.

Moreover, configuration can take place automated, and for this purpose the configuration controller 36 can be connected to a higher-level administrator control over a network 62 which can optionally also be wireless. In FIG. 6 the components 60, the configuration module 22 and the control module 30 of the two data processing means 64, 66 are each designed in one unit. These components however can also be distributed in the data processing means 64, 66. The control network 34 with which the control modules 30 are connected to the configuration controller 36 can also be made wireless.

FIG. 7 shows an arrangement of components 60 which are each connected to a configuration module 22 and are designed in one unit. The configuration modules 22 are connected to the control module 30 over connecting lines 29. Even if the components 60 in FIG. 7 are identical, they may be completely different components 60 of the data processing system which is to be configured, for example hard disks, drives, random access memories, processors or the like. It is however also possible to hold a plurality of components 60 which are built essentially identically, for example hard disks, and depending on the requirement to incorporate them into the data processing system which is to be configured. For this purpose, the components 60 can be connected over their respective configuration module 22, the connecting line 29 and the control module 30 can be connected over the control network 34 to other components which are located remotely.

FIG. 8 shows an arrangement as claimed in the invention of a device 1001 which is installed as a built-in card into a first data processing means 1002 which is a personal computer. The device 1001 can be installed for example on the back of the housing of the first data processing means 1002 in a standard rack such that the electrical and/or optical connection means which lead to the outside are accessible outside the housing.

The first data processing means 1002 is networked by data engineering to other data processing means 1004, 1006, 1008, 1010, in the embodiment over a data network 1012 with ring network topology. Two of the other data processing means 1004, 1006 are designed essentially identical to the first data processing means 1002, in particular the other two data processing means 1004, 1006 also have a device 1001 as claimed in the invention. These three data processing means 1002, 1004, 1006 can be for example conventional workstation computers, workstations or personal computers.

Conversely, the other data processing means 1010 assumes a server function in the data network 1012, i.e., it is a high-performance computer on which for example standard data are kept, including application programs which are accessed by the other data processing means 1002, 1004, 1006. The data network 1012 can be operated for example according to the TCP/IP protocol or according to the Ethernet standard.

In addition to the data network 1012, the arrangement of FIG. 8 has a network 1016 which can be regarded as a monitoring network and to which both the devices 1001 of the first data processing means 1002 and the other data processing means 1004, 1005 are connected, and also a controller 1014 which is located in a second data processing means 1008. The second data processing means 1008 can also be designed as a workstation computer; alternatively there can also be a device which can be addressed simply over one of the data processing means 1002, 1004, 1006 or especially from the server 1010. In a modification of FIG. 8 the server 1010 can also be connected via a device 1001 to the network 1016. The network 1016 also has a ring topology. The devices 1001 in the data processing means 1002, 1004, 1006 are supplied with power over the network 1016. This power originates preferably from the controller 1014 of the second data processing means 1008 or from a hub or switch which is connected to the network 1016.

FIG. 9 shows one alternative arrangement in which the data processing means 1002, 1004, 1006 which are designed essentially identically and which each have a device 1001 as claimed in the invention are connected to one another over a data network 1112 with bus topology and to the server 1010 and the data processing means 1008 which has the controller 1014. The topology with which the controller 1014 is connected to the devices 1001 is star-shaped in this embodiment, an active distributor 1018, for example a so-called hub or a switch, being connected between the controller 1014 and the devices 1001.

FIG. 10 shows another possible arrangement of the data processing means 1002, 1004, 1006 which have been equipped as claimed in the invention, in this embodiment the data network 1212 and the network 1216 being integrated in a common network so that separate wiring for the network 1216 is not necessary. The common network 1212, 1216 is implemented with a bus topology in which the computers are linearly connected by way of a common cable which forms the bus. The can be divided for this purpose at a site which is assigned to the respective data processing means 1002, 1004, 1006, 1008, 1010, and a first terminal line 1020a can be supplied to the existing network card of the data processing means 1002, while a second terminal line 1020b is supplied to the device 1001 as claimed in the invention, for the two terminal lines 1020a, 1020b there being their own terminal elements, for example receptacles, on the data processing means 1002. In another configuration level in which the protocol of the data network 1212 is integrated into the functionality of the network 1216, a single terminal line with a single terminal element can be used.

In all three embodiments as shown in FIGS. 8 to 11, the data processing means 1002, 1004, 1006 can be turned on, turned off or reset by the data processing means 1008 in which the controller 1014 is installed, over the network 1016, 1116, 1216. For this purpose, the devices 1001 are connected to the electrical switching device of the respective data processing means 1002, 1004, 1006, which device causes turning on, turning off or resetting, and the connection can take place conductively or without contact, for example by way of an optical coupler or a relay, especially a reed relay. Either single or several of the data processing means 1002, 1004, 1006 can be triggered individually over the network 1016, 1116, 1216, or all data processing means 1002, 1004, 1006 which are connected to the network 1016, 1116, 1216 can be monitored jointly.

The second data processing means 1008 and especially the controller 1014 which has been installed there can be controlled by a system administrator which can be located at any network node, especially both on the server 1010 and also on one of the other data processing means 1002, 1004,1006, 1008.

FIG. 11 shows the wiring of a device 1001 as claimed in the invention with a main board 1022 of the pertinent data processing means 1002. The main board 1022 in addition to a processor 1024 has numerous interfaces for other components of the data processing means 1002, including interfaces 1026 for memory modules, interfaces 1028 for disk drives, an interface 1030 for a graphics card, several interfaces 1032 for plug-in cards, for example with a PCI bus, and at least one parallel interface 1034, one serial interface 1036, one USB interface 1038 and one audio interface 1040. The other components of the data processing means 1002 can be connected by plugging into the main board 1022 or by connecting lines to the main board 1022. The main board 1022 can be connected to a data network 1012 over a network card which is designed as a plug-in card or a built-in card.

Moreover, the data processing means 1002 has, either directly on the main board 1022 or connected to it over a connecting line, a panel 1042 which forms one or more interfaces to other components of the data processing means 1002. Thus the panel 1042 can have for example terminal lines for light emitting diodes with which the operating position and/or disk access of a disk memory can be displayed. Moreover, a speaker can be connected to the panel 1042. In addition, there are also terminals of a System Management Interrupt (SMI) lead, by means of which the data processing means 1002 can be shifted into the energy saving mode.

FIG. 11 shows, simply for the sake of greater clarity, of all these terminal possibilities of the panel 1042, only the terminals for the so-called reset switch or button 1044 which is located conventionally on the housing of the data processing means 1002 and the terminals for the on/off switch or button 1046. In many modern data processing means 1002 a so-called ATX power switch or power button is used, by which the data processing means 1002 can be shifted out of the power saving mode by a key signal into the operating mode, and depending on the operating system, the data processing means 1002 can also be ramped down and turned off by touching.

In a known data processing means 1002 the connecting lines are routed between the panel 1042 and the switching devices 1044, 1046, as is indicated in FIG. 11 by the broken lines. According to this invention the connecting lines are routed over switching devices which are located on the board of the device 1001. Here a first additional switching device 1044a assumes the function of the reset button 1044, in this version simultaneous actuation of the switching device 1044 which is located on the housing of the data processing means 1002 and of the first additional switching device 1044a by the device 1001 being possible and also effective. But this can be prevented by opening of the second additional switching device 1044x, which opening is controlled by the controller 1014, so that only then is actuation of the reset button 1044 by the device 1001 possible. The device 1001 is connected over the network 1016 to the controller 1014, the control of the device 1001 for actuating the other switching devices 1044a, 1044x being DC-isolated from the looped-through connecting lines.

Analagously, the on/off button 1046 which has a connecting line which is likewise looped via the device 1001, a first additional switching device 1046a being located parallel to the on/off button 1046 which is located on the housing of the data processing means 1002, and a second additional switching device 1046x being connected in series to the housing switching device 1046.

Analogously, other interfaces of the main board 1022 can also be looped via the device 1001 and therefore the data processing means 1002 can be monitored partially or completely by the device 1001 and consequently by the controller 1014. For example, over the network 1016 the device 1001 can provide for specific interfaces being deactivated temporarily or permanently, for example an audio signal not being output, a video signal not being output, or data transfer over the parallel, serial, and/or USB interface 1034, 1036, 1038 not being possible. In particular, several or all interfaces of the panel 1042 can be looped through via the device 1001 so that triggering of the light emitting diodes or of the system speaker of the data processing means 1002 is possible by the device 1001.

Alternatively or in addition, a first sensor 1048 is also connected to the device 1001 and for example detects whether the housing of the data processing means 1002 is closed or opened. Furthermore, a second sensor 1050 is connected to the device 1001 and with it acoustic and/or optical ambient signals are recorded, for example the state of specific components of the data processing means 1002 is monitored. A power supply line 1054 connects the power supply unit 1052 of the data processing means 1002 to the device 1001 so that it can be easily detected whether the data processing means 1002 has been turned on or off by the user.

FIG. 12 shows the wiring of the device 1001 as claimed in the invention with the USB interface 1038 or the pertinent USB port 1056 on the main board 1022. In the initial state the USB port 1056 is connected directly to the USB interface 1038, as is indicated by the broken line 1058. As claimed in the invention the USB port 1056 can be connected to the USB interface 1038 via a switching device 1060 which in the embodiment is located on a board of the device 1001 and is connected via the connecting lines 1062 to the main board 1022.

The switching of the connection is controlled by a control means 1064 of the device which communicates preferably bidirectionally over the network 1016 with the controller 1014, as is shown by the double arrow 1066. To this end the control means 1064 can transmit not only the state of the switching means 1060 to the controller 1014 or change it according to a stipulation of the controller 1014, but the data which have been transmitted over the interface 1038 can also be sent to the controller 1014.

In particular for the USB interface it can be advantageous to design the device 1001 as claimed in the invention, not as a built-in card, but as a plug-in device which has a USB plug and can be plugged into a USB receptacle of the data processing means 1002. In this way the mounting of the device 1001 is further simplified. The device 1001 can for its part in turn have one or more USB receptacles into which the peripherals of the data processing means can be plugged. The USB receptacles of the device 1001 and the connected peripherals can be controlled or monitored as claimed in the invention.

The housing of the device 1001 can moreover have connecting elements for the network 1016, especially a corresponding receptacle. Therefore the device 1001 as claimed in the invention is obtained which is easily plugged in between the data processing system 1002 and the peripheral and apart from a terminal to the network 1016 does not require any other connection. Removal of the device 1001 from the USB slot of the data processing means 1002 is recognized by the device 1001 and reported to the controller 1014 by way of the network 1016.

Analogously other interfaces, for example the parallel interface 1034, the RS 232 serial interface 1036, etc., can also be monitored and/or controlled by means of the device 1001.

1. System for configuring a data processing system (1), the data processing system (1) having a plurality of components such as a processor (6), main board (4), memory, input/output component (20), power supply component (2) or the like, which can be connected to one another for the configuration of the data processing system (1), characterized in that the system has at least one configuration module (22) which is interposed into the connection of at least two components, that the system has a control module (30) which can be connected to the configuration module (22), that following a signal sent from the control module (30) to the configuration module (22) a connection can be made available between the at least two components, and that by making available the connection between the at least two components the data processing system (1) can be configured.

2. The system as claimed in claim 1, wherein a virtual connection can be made available between the at least two components, for example by time-sharing of the connected components.

3. The system as claimed in claim 1, wherein from the configuration module (22) data from at least one of the components connected to the configuration module (22) can be transmitted to the control module (30) and/or from the control module (30) data can be transmitted to at least one of the components connected to the configuration module (22).

4. The system as claimed in claim 1, wherein the signals and/or data can be transmitted wirelessly between the configuration module and the control module (30).

5. The system as claimed in claim 1, wherein the control module (30) has a network terminal (32) over which the control module (30) can be connected to a control network (34), and wherein control information for connecting the components can be received from the control module (30) over the control network (34).

6. The system as claimed in claim 5, wherein data from at least one of the components connected to the configuration module (22) can be transmitted over the control network (34) and/or data for at least one of the components connected to the configuration module (22) can be received over the control network (34).

7. The system as claimed in claim 5, wherein the power necessary for operation of the control module (30) and/or of the configuration module (22) can be transmitted over the control network (34).

8. The system as claimed in claim 5, wherein the power necessary for operation of at least one of the components of the data processing system (1) can be transmitted over the control network (34).

9. The system as claimed in claim 1, wherein the components connected to the configuration module (22) can be DC-isolated from the other components of the data processing system (1).

10. The system as claimed in claim 1, wherein the data processing system (1) can be configured using components of different data processing means (64, 66) which are each of themselves independently serviceable, and preferably also after configuration of the data processing system (1) are independently serviceable.

11. The system as claimed in claim 1, wherein some of the components of the data processing system (1) which has been configured by the system are located spatially remote from the other components of the data processing system (1) which has been configured by the system.

12. The system as claimed in claim 1, wherein at least some of the components of the data processing system (1) which has been configured by the system are located in a pool of components which are retained for configuration.

13. Process for configuring a data processing system (1), the data processing system (1) having a plurality of components such as a processor (6), main board (4), memory, input/output component (20), power supply component (2) or the like which can be connected to one another for the configuration of the data processing system (1), the system having at least one configuration module (22) which is interposed into the connection of at least two components, the system having a control module (30) which is connected to the configuration module (22), a signal being sent from the control module (30) to the configuration module (22), as a result a connection being made available between at least two components, and by making available the connection between at least two components the data processing system (1) being configured.

14. Device (1001), especially a built-in card, for a data processing means (1002), for example for a computer, a printer, or the like, the data processing means (1002) being networked by data engineering to at least one other data processing means (1004, 1006), and the data processing means (1002) having a main board (1022) with interfaces (1026, 1028, 1030, 1032, 1034, 1036, 1040, 1042) for additional components of the data processing means (1002) and/or for interaction of the data processing means (1002) with a user, including an interface (1034, 1036, 1038) for sending and/or receiving data to or from a peripheral of the data processing means (1002), and the device (1001) being connected over a network (1016) to a controller (1014), wherein the device (1001) has a power supply which is independent of the data processing means (1002) by way of the network (1016), and wherein the device (1001) is connected to at least one of the interfaces (1034, 1036, 1038) for sending/or receiving data to or from a peripheral of the data processing means (1002).

15. The device (1001) as claimed in claim 14, wherein the device (1001) can prevent data traffic over the interface (1034, 1036, 1038) for sending and/or receiving data to or from a peripheral of the data processing means (1002).

16. The device (1001) as claimed in claim 14, wherein the device (1001) can monitor data traffic over the interface (1034, 1036, 1038) for sending and/or receiving data to or from a peripheral of the data processing means (1002).

17. The device (1001) as claimed in claim 14, wherein the device (1001) is connected to a Universal Serial Bus (USB) interface.

18. The device (1001) as claimed in claim 14, wherein the device (1001) is connected to an interface (1042a, 1042b) of the data processing means (1002) to an electrical switching device (1044, 1046), by activation of which the data processing means (1002) can be turned on, turned off, or reset.

19. The device (1001) as claimed in claim 14, wherein the device (1001) is connected to a system management interrupt interface of the main board (1022).

20. The device (1001) as claimed in claim 14, wherein the device (1001) has at least one sensor element (1048, 1050) for recording the status of the data processing means (1002) or of ambient conditions and for transmitting the status information to the controller (1014) over the network (1016).

21. The device (1001) as claimed in claim 14, wherein the data processing means (1002) can be shifted by the device (1001) into the operating state in which interaction with the data processing means (1002) is possible only by way of the device (1001), the network (1016) and the controller (1014).

22. The device (1001) as claimed in claim 14, wherein the network (1016) for a connection between the device (1001) and the controller (1014) is DC-isolated from the data engineering networking of the data processing means (1002) to at least one other data processing means (1004, 1006).

23. The device (1001) as claimed in claim 14, wherein the connection between the device (1001) and the controller (1014) and the data engineering networking of the data processing means (1002) to at least one other data processing means (1004, 1006) are integrated in a common network (1212, 1216), especially wherein the connection between the device (1001) and the controller (1014) as well as the data engineering networking of the data processing means (1002) to at least one other data processing means (1002) takes place by way of a standardized network protocol and a common network.

24. The device (1001) as claimed in claim 14, wherein the device (1001) is designed as a built-in card which can be installed in the rack of the data processing means (1002), which rack is standardized with respect to the geometrical dimensions of its acceptance opening.

25. The device (1001) as claimed in claim 14, wherein the device (1001) is designed as an adapter plug which can be plugged into a plug element of the data processing means (1002), which element is accessible from the outside, and into which plug elements of peripherals can be plugged.
